(19) United States
(12) Patent Application Publication
(10) Pub. No.: US 2019/0016936 A1
(43) Pub. Date: Jan. 17, 2019

(54) ABRASIVE PARTICLES AND METHOD OF FORMING SAME

(71) Applicant: Saint-Gobain Ceramics & Plastics, Inc., Worcester, MA (US)

(72) Inventors: Ralph BAUER, Niagara Falls (CA); Jennifer H. CZEREPINSKI, Framingham, MA (US); Eric MOCH, Allston, MA (US); Nabil NAHAS, Waltham, MA (US); Stefan VUJCIC, Buffalo, NY (US)

(21) Appl. No.: 16/066,993

(22) PCT Filed: Jun. 29, 2016
(86) PCT No.: PCT/US2016/040035

§ 371 Date: Jun. 28, 2018

Related U.S. Application Data
(60) Provisional application No. 62/273,117, filed on Dec. 30, 2015.

(51) Int. Cl. C09K 3/14

(52) U.S. Cl. CPC C09K 3/1409; C09K 3/1436

(57) ABSTRACT

In an embodiment, an abrasive particle comprises a body including alumina, the alumina including a plurality of crystallites having an average crystallite size of not greater than 0.18 microns. In other embodiments, the body further comprises magnesium and zirconia. The abrasive particle has at least one of an average strength of not greater than 1000 MPa or a relative friability of at least 105%.

### TECHNICAL FIELD

The following is directed to abrasive particles, and more particularly, to abrasive particles having certain features and methods of forming such abrasive particles.

### BACKGROUND ART

Abrasive articles incorporating abrasive particles are useful for various material removal operations including grinding, finishing, polishing, and the like. Depending upon the type of abrasive material, such abrasive particles can be useful in shaping or grinding various materials in the manufacturing of goods.

The production of abrasive particles, particularly alumina abrasive particles, having very fine crystalline sizes has been utilized for over 20 years. Notably, such abrasive particles are typically formed by a seeding process, as disclosed in U.S. Pat. No. 4,623,364. The small particle size of the gel particles and the use of nucleating seeds aid the conversion of the raw material to alpha alumina and facilitate the creation of ceramic materials). Low sintering temperatures (e.g., 1200°-1400° C.), fine microstructures, and high density are realized when seeded gels are utilized. Forming abrasive particles using such methods has been shown to create abrasive particles that are significantly improved compared to fused alumina or alumina-zirconia abrasives. The fine crystal structure achievable by this process also allows the production of shaped alpha alumina bodies having substantially improved properties. While various publications on seeded sol gel alumina have claimed sub-micron crystalline sizes, there have been limitations on the average crystalline sizes that could be achieved.

The industry continues to desire improved ceramic materials, including those for use as abrasive particles.

### SUMMARY

According to a first aspect, an abrasive particle includes a body including alumina including a plurality of crystallites having an average crystallite size of not greater than 0.18 microns, and wherein the body further comprises at least one of an average strength of not greater than 1000 MPa or a relative friability of at least 105%.

In yet another aspect, an abrasive particle includes a body including alumina and at least one intergranular phase, the body including a plurality of crystallites having an average crystallite size of not greater than 0.18 microns, and wherein the body further comprises at least one of an average strength of not greater than 1000 MPa or a relative friability of at least 105%.

For another embodiment, an abrasive particle includes a body having a polycrystalline material including a plurality of crystallites comprising alumina, wherein the crystallites have an average crystallite size of not greater than 0.18 microns, a first intergranular phase comprising magnesium, a second intergranular phase comprising zirconia, and at least one of an average strength of not greater than 1000 MPa or a relative friability of at least 105%.

According to another aspect, an abrasive particle includes a body having a polycrystalline material including a plurality of crystallites comprising alumina, wherein the crystallites have an average crystallite size of not greater than 0.12 microns, a first intergranular phase comprising magnesium, a second intergranular phase comprising zirconia, and at least one of an average strength of not greater than 1000 MPa, a relative friability of at least 105%, and a theoretical density of at least 98.5%.

In yet another aspect, an abrasive particle comprises a body including alumina, the alumina including a plurality of crystallites having an average crystallite size of not greater than 0.12 microns, and wherein the body has at least one of an average strength of not greater than 1000 MPa, a relative friability of at least 105%, or a theoretical density of at least 98.5%.

### BRIEF DESCRIPTION OF THE DRAWINGS

The present disclosure may be better understood, and its numerous features and advantages made apparent to those skilled in the art by referencing the accompanying drawings.

FIGS. 1A and 1B include scanning electron microscope (SEM) photomicrographs for measuring the average crystallite size of a polycrystalline body using the uncorrected intercept method.

FIG. 2 includes a perspective view illustration of a shaped abrasive particle according to an embodiment.

FIG. 3A includes a perspective view illustration of a shaped abrasive particle according to an embodiment.

FIG. 3B includes a perspective view illustration of a crushed abrasive particle according to an embodiment.

FIG. 4 includes a cross-sectional view illustration of a coated abrasive article according to an embodiment.

FIG. 5 includes a cross-sectional view illustration of a bonded abrasive article according to an embodiment.

FIG. 6 includes a cross-sectional SEM image of a portion of an abrasive particle according to an embodiment.

### DETAILED DESCRIPTION OF THE PREFERRED EMBODIMENT(S)

The following is directed to methods of forming abrasive particles. The abrasive particles of the embodiments herein may be used in various abrasive applications, including for example, fixed abrasive articles, such as bonded abrasives and coated abrasives. Alternatively, the shaped abrasive particle fractions of the embodiments herein may be utilized in free abrasive technologies, including for example grinding and/or polishing slurries.

Suitable methods of forming the abrasive particles can include the formation of a mixture, such as a sol-gel. The mixture may contain a certain content of solid material, liquid material, and additives such that it has suitable rheological characteristics for use with the process detailed herein. The mixture can be formed to have a particular content of solid material, such as the ceramic powder material. For example, in one embodiment, the mixture can have a solids content of at least 25 wt %, such as at least 35 wt % or at least 38 wt % or at least 40 wt % or at least 45 wt % or at least 50 wt % for the total weight of the mixture. Still, in at least one non-limiting embodiment, the solids content of the mixture can be not greater than about 75 wt %, such as not greater than about 70 wt %, not greater than about 65 wt %, not greater than about 55 wt %, not greater than about 45 wt %, or not greater than about 40 wt % or not greater than 35 wt %. It will be appreciated that the content of the solid material in the mixture 101 can be within a range between any of the minimum and maximum percentages noted above.

According to one embodiment, the ceramic powder material can include an oxide, a nitride, a carbide, a boride, an oxycarbide, an oxynitride, and a combination thereof. In particular instances, the ceramic material can include alumina. More specifically, the ceramic material may include a boehmite material, which may be a precursor of alpha alumina. The term “boehmite” is generally used herein to denote alumina hydrates including mineral boehmite, typically being Al2O3.H2O and having a water content on the order of 15%, as well as pseudoboehmite, having a water content higher than 15%, such as 20-38% by weight. It is noted that boehmite (including pseudoboehmite) has a particular and identifiable crystal structure, and therefore a unique X-ray diffraction pattern. As such, boehmite is distinguished from other aluminous materials including other hydrated aluminas such as ATH (aluminum trihydroxide), a common precursor material used herein for the fabrication of boehmite particulate materials.

According to one embodiment, the ceramic powder can have a median particle size of not greater than 100 microns. In other embodiments, the median particle size of the raw material ceramic powder can be less, such as not greater than 80 microns or not greater than 50 microns or not greater than 30 microns or not greater than 20 microns or not greater than 10 microns or not greater than 1 micron or not greater than 0.9 microns or not greater than 0.8 microns or not greater than 0.7 microns or even not greater than 0.6 microns. Still, the median particle size of the ceramic powder can be at least 0.01 microns, such as at least 0.05 microns or at least 0.06 microns or at least 0.07 microns or at least 0.08 microns or at least 0.09 microns or at least 0.1 microns or at least 0.12 microns or at least 0.15 microns or at least 0.17 microns or at least 0.2 microns or even at least 0.5 microns. It will be appreciated that the ceramic powder can have an average grain size within a range including any of the minimum and maximum values noted above.

According to one embodiment, the ceramic powder can be a polycrystalline material having a median crystalline size of not greater than 2 microns. In other embodiments, the median crystalline size of the raw material ceramic powder can be less, such as not greater than 1 micron or not greater than 0.5 microns or not greater than 0.3 microns or not greater than 0.2 microns or not greater than 0.15 microns or not greater than 0.1 microns or not greater than 0.09 microns or not greater than 0.08 microns or not greater than 0.07 microns or not greater than 0.06 microns or not greater than 0.05 microns or not greater than 0.04 microns or not greater than 0.03 microns or not greater than 0.02 microns. Still, the median crystalline size of the raw material ceramic powder can be at least 0.001 microns, such as at least 0.005 microns or at least 0.006 microns or at least 0.007 microns or at least 0.008 microns or at least 0.009 microns or at least 0.01 microns or at least 0.015 microns or at least about 0.02 microns or at least 0.025 microns or at least 0.03 microns. It will be appreciated that the raw material ceramic powder can have an average crystalline size within a range including any of the minimum and maximum values noted above.

In at least one embodiment, the ceramic powder may have a particular specific surface area that may facilitate formation of the embodiments herein. For example, the ceramic powder can have a specific surface area of at least 50 m²/g or at least 60 m²/g or at least 70 m²/g or at least 80 m²/g or at least 90 m²/g or at least 100 m²/g or at least 110 m²/g or at least 120 m²/g or at least 130 m²/g or at least 140 m²/g or at least 150 m²/g or at least 200 m²/g. In one non-limiting embodiment, the ceramic powder may have a specific surface area of not greater than 350 m²/g or not greater than 300 m²/g or not greater than 250 m²/g. It will be appreciated that the ceramic powder may have a specific surface area within a range including any of the minimum and maximum values noted above.

Furthermore, the mixture can be formed to have a particular content of liquid material. Some suitable liquids may include water. In more particular instances, the mixture can have a liquid content of at least 8% for the total weight of the mixture. In other instances, the amount of liquid within the mixture can be greater, such as at least 10 wt % or at least 15 wt % or at least 18 wt % or at least 20 wt % or at least 22 wt % or at least about 25 wt % or at least about 28 wt % or at least about 30 wt % or at least about 35 wt % or even at least about 40 wt %. Still, in at least one non-limiting embodiment, the liquid content of the mixture can be not greater than 75 wt % for the total weight of the mixture, such as not greater than 70 wt % or not greater than 65 wt % or not greater than about 60 wt % or not greater than 50 wt % or not greater than 40 wt % or not greater than 30 wt % or not greater than 25 wt % or not greater than 20 wt %. It will be appreciated that the content of the liquid in the mixture can be within a range including any of the minimum and maximum percentages noted above.

The mixture can be formed to have a particular content of organic materials including, for example, organic additives that can be distinct from the liquid to facilitate processing and formation of shaped abrasive particles according to the embodiments herein. Some suitable organic additives can include stabilizers, binders such as fructose, sucrose, lactose, glucose, UV curable resins, and the like.

The embodiments herein may utilize a mixture that can be distinct from slurries used in conventional forming operations. For example, the content of organic materials within the mixture and, in particular, any of the organic additives noted above, may be a minor amount as compared to other components within the mixture. In at least one embodiment, the mixture can be formed to have not greater than 30 wt % organic material for the total weight of the mixture. In other instances, the amount of organic materials may be less, such as not greater than 15 wt %, not greater than 10 wt %, or even not greater than 5 wt %. Still, in at least one non-limiting embodiment, the amount of organic materials within the mixture can be at least 0.01 wt %, such as at least 0.5 wt % for the total weight of the mixture. It will be appreciated that the amount of organic materials in the mixture can be within a range between any of the minimum and maximum values noted above.

The process of forming the mixture can further include the addition of one or more additives. For example, the mixture can be formed to have a particular content of acid or base, distinct from the liquid content, to facilitate processing and formation. Some suitable acids or bases can include nitric acid, sulfuric acid, citric acid, chloric acid, tartaric acid, phosphoric acid, ammonium nitrate, and ammonium citrate. According to one particular embodiment in which a nitric acid additive is used, the mixture can have a pH of less than about 5, and more particularly, can have a pH within a range between about 2 and about 4. The content of acid can be relatively minor (in weight percent) compared to the content of the other solid components (i.e., the ceramic powder). For example, in at least one embodiment, the mixture can include a ratio of acid/ceramic powder (as measured by their respective weights in the mixture) as not greater than 1, such as not greater than 0.5 or not greater than 0.2 or not greater than 0.1 or even not greater than 0.05. In another embodiment, the ratio of acid/ceramic powder can be at least 0.0001 or at least 0.001 or even at least 0.01. It will be appreciated that the ratio of acid/ceramic powder can be within a range between any of the minimum and maximum values noted above.

The mixture can also be formed with a particular content of seeds, which may facilitate formation of a certain high temperature phases of material. For example, in the context of a mixture including boehmite, the seed material can include alpha alumina, which can facilitate the transformation of the boehmite to alpha alumina during thermal treatment. According to one embodiment, the content of seeds in the mixture can be in a minor content compared to the total weight of the mixture or the total weight of the raw material ceramic powder, but may be present in greater content than used in some conventional forming processes. For example, the mixture can include at least 1 wt % seed material for a total weight of the raw material ceramic powder, such as at least 1.5 wt % or at least 1.8 wt % or at least 1.9 wt % or at least 2 wt % or at least 2.1 wt % or at least 2.2 wt % or at least 2.3 wt % or at least 2.4 wt % or at least 2.5 wt % or at least 2.6 wt % or at least 2.7 wt % or at least 2.8 wt % or at least 2.9 wt % or at least 3 wt % or at least 3.1 wt % or at least 3.2 wt % or at least 3.3 wt % or at least 3.4 wt % or at least 3.5 wt % or at least 3.6 wt % or at least 3.7 wt % or at least 3.8 wt % or at least 3.9 wt % or at least 4 wt % or at least 4.1 wt % or at least 4.2 wt % or at least 4.3 wt % or at least 4.4 wt % or at least 4.5 wt %. Still, in another non-limiting embodiment, the mixture can include a content of seed material of not greater than 10 wt % for a total weight of the raw material ceramic powder or not greater than 9 wt % or not greater than 8 wt % or not greater than 7 wt % or not greater than 6 wt % or not greater than 5.5 wt % or not greater than 5.2 wt % or not greater than 5 wt % or not greater than 4.8 wt % or not greater than 4.5 wt % or not greater than 4.2 wt % or not greater than 4 wt % or not greater than 3.8 wt % or not greater than 3.5 wt % or not greater than 3.2wt % or not greater than 3 wt % or not greater than 2.8 wt % or not greater than 2.5 wt %. It will be appreciated that the mixture can include a content of seed material within a range between any of the minimum and maximum percentages noted above.

In at least one embodiment, the seed material may have a particular specific surface area that may facilitate formation of the embodiments herein. For example, the seed material can have a specific surface area of at least 30 m²/g or at least 35 m²/g or at least 40 m²/g or at least 45 m²/g or at least 50 m²/g or at least 55 m²/g or at least 60 m²/g or at least 65 m²/g or at least 70 m²/g or at least 75 m²/g or at least 80 m²/g or at least 90 m²/g. In one non-limiting embodiment, the seed material may have a specific surface area of not greater than 200 m²/g or not greater than 180 m²/g or not greater than 160 m²/g or not greater than 150 m²/g or not greater than 140 m²/g or not greater than 130 m²/g or not greater than 120 m²/g or not greater than 110 m²/g. It will be appreciated that the seed material may have a specific surface area within a range including any of the minimum and maximum values noted above.

After forming the mixture, which may be in the form of a gel, an optional centrifuging process may occur to remove large particles.

The mixture may also be formed to include one or more additives, such as dopants, which may function as pinning agents and/or other microstructural modifying agents. Such additives may be added to the mixture prior to drying or significant heat treatment as a dopant. Alternatively, one or more additives may be added to the material after the mixture has been calcined, such that the calcined material is impregnated with one or more additives. Some such suitable additives can include one or more inorganic compounds or precursors of such inorganic compounds. The inorganic compounds can include an oxide, carbide, nitride, boride, silicon, or a combination thereof. In one particular embodiment, the additive can include an oxide compound including at least one alkali element (Group I of the Periodic Table of Elements), alkaline earth element (Group II of the Periodic Table of Elements), a transition metal element, a lanthanoid, or a combination thereof. According to a particular embodiment, some suitable additives can include silicon, lithium, sodium, potassium, magnesium, calcium, strontium, scandium, titanium, vanadium, chromium, manganese, iron, cobalt, nickel, zinc, yttrium, zirconium, niobium, molybdenum, lanthanum, hafnium, tantalum, tungsten, cerium, praseodymium, neodymium, samarium or a combination thereof.

In some instances, it may be desirable to shape the mixture, such as in the formation of shaped abrasive particles. Shaping operations can include, but are not limited to, molding, casting, punching, pressing, printing, depositing, cutting, or a combination thereof. In at least one embodiment, the mixture may be formed in the openings of a production tooling (e.g., a screen or mold), and formed into a precursor shaped abrasive particle. Screen printing methods of forming shaped abrasive particles are generally described in U.S. Pat. No. 8,753,558. A suitable method of forming shaped abrasive particles according to a molding process is described in U.S. Pat. No. 9,200,187.

After forming the mixture, the process may further include drying of the mixture to remove a particular content of material, including volatiles, like water and/or organics. In accordance with an embodiment, the drying process can be conducted at a drying temperature of not greater than 300° C., such as not greater than 280° C. or even not greater than 250° C. Still, in one non-limiting embodiment, the drying process may be conducted at a drying temperature of at least 50° C. It will be appreciated that the drying temperature may be within a range between any of the minimum and maximum temperatures noted above.

Furthermore, the drying process may be conducted for a particular duration. For example, the drying process may be at least 10 seconds, such as at least 15 seconds or at least 20 seconds or at least 25 seconds or at least 30 seconds or at least 40 seconds or at least 50 seconds or at least 1 minute or at least 2 minutes or at least 5 minutes or at least 10 minutes or at least 15 minutes or at least 30 minutes. Still, in one non-limiting embodiment, the drying process may last for a duration of not greater than 72 hours, such as not greater than 60 hours or not greater than 48 hours or not greater than 24 hours or not greater than 15 hours or not greater than 10 hours or not greater than 8 hours or not greater than 4 hours or not greater than 2 hours or not greater than 1 hour or not greater than 30 minutes or not greater than 15 minutes or not greater than 10 minutes. It will be appreciated that the drying duration may be within a range including any of the minimum and maximum temperatures noted above.

The dried material can then be crushed if formed into irregular (i.e., unshaped) abrasive particles. Conventional crushing operations may be utilized. The process may also utilized suitable sorting processes, including sieving. Such sorting processes may also be utilized later in the process.

After sufficient drying, the material can be calcined to remove any further water and facilitate some phase transformations of the material. The calcination temperature can be varied depending upon the material. In one embodiment, the calcination temperature can be at least 700° C., such as at least 800° C. or at least 900° C. or at least 920° C. or at least 950° C. or at least 970° C. or even at least 1000° C. Still, in one non-limiting embodiment, the calcination temperature can be not greater than 1200° C. or not greater than 1100° C. or not greater than 1080° C. or even not greater than 1050° C. It will be appreciated that the calcination temperature may be within a range including any of the minimum and maximum temperatures noted above.

Furthermore, the calcination process may be conducted for a particular duration at the calcination temperature. For example, the calcination process may include calcining the material at the calcination temperature for at least 1 minute, such as at least 5 minutes or at least 10 minutes or at least 15 minutes or at least 30 minutes. Still, in one non-limiting embodiment, the calcination process may last for a duration of not greater than 10 hours at the calcination temperature, such as not greater than 5 hours or not greater than 2 hours or not greater than 1 hour or not greater than 30 minutes or not greater than 20 minutes. It will be appreciated that the duration at the calcination duration may be within a range including any of the minimum and maximum temperatures noted above.

In at least one embodiment, calcination may occur at standard atmospheric conditions, including a standard pressure (at sea level) and atmosphere (air). Still, it will be appreciated that the calcination process may be conducted in different conditions, such as utilization of other pressures and atmospheres. Such differences may also include corresponding changes in the calcination temperature and duration at the calcination temperature.

After calcination a calcined material is obtained. The calcined material may optionally be impregnated with one or more additives, such as a dopant or precursors of dopant materials desired to be present within the finally-formed material. The additives can include any of the previously identified additives as noted herein. In certain instances, the process of impregnation can include saturation of the porosity of the raw material powder with the additive. Saturation can include filling at least a portion of the pore volume of the calcined material with the additive or additive precursor. Still, a saturation process may include filling a majority of the porosity with the additive or additive precursor, and more particularly, may include filling substantially all of the total pore volume of the raw material powder with the additive. The saturation process, which may further include an over-saturation process, can utilize processes including, but not limited to, soaking, mixing, stirring, increased pressure above atmospheric conditions, decreased pressure below atmospheric conditions, particular atmospheric conditions (e.g., inert atmosphere, reducing atmosphere, oxidizing atmosphere), heating, cooling, and a combination thereof. In at least one particular embodiment, the process of impregnation can include soaking the calcined material in a solution containing the additive or additive precursor.

In certain instances, the additive can include more than one component. For example, the additive may include a first component and a second component distinct from the first component. In accordance with an embodiment, the first component may include a first additive or first additive precursor. According to certain embodiments, the first component may include a salt, and may be present as a solution including the first additive. For example, the first component may include an additive element in the form of a compound, which may be dissociated in a liquid carrier (e.g., water). Such a compound may include a salt, such as a nitrate, carbonate, and the like.

As noted above, impregnation can include the addition of one or more components. In at least one embodiment, the impregnation process can include the addition of a second component, which can include a second additive distinct from the first additive. The second additive can be in the form of a compound as described above.

The amount of the additives impregnated within the calcined material can be varied depending upon the desired content of the additives within the finally-formed abrasive particles. According to one embodiment, the calcined material may be impregnated with a significant content of additives, which may be greater than conventional contents of such additives, because the finally-formed microstructure of the abrasive particles can facilitate such contents of the additives.

The first and second components can be impregnated within the calcined material simultaneously using a single mixture or dispersion containing both components (and additives). Still, in other instances, it may be advantageous to add the components separately, such that the impregnation process may include a first impregnation of the first additive or additive precursor, and thereafter a second impregnation of the second additive or additive precursor. For example, in one embodiment, the process of including the additive can include providing the first component at a first time and the second component at a second time different than the first time. For example, the first component may be added before the second component. Alternatively, the first component may be added after the second component.

The process of including an additive can include performing at least one process between the addition of the first component and the addition of the second component to the calcined material. For example, some exemplary processes that may be conducted between the addition of the first component and the second component can include mixing, drying, heating, and a combination thereof. In one particular embodiment, the process of including the additive may include providing the first component to the calcined material, heating the calcined material after the addition of the first component and providing the second component to the calcined material.

After calcining and impregnation, the process may continue with sintering of the calcined material. Sintering may be conducted to facilitate densification and formation of high temperature phases of the calcined material. For example, sintering may be conducted at a sintering temperature of at least 600° C., such as at least 700° C. or at least 800° C. or at least 900° C. or at least 1000° C. or at least 1100° C. or at least 1150° C. or at least 1200° C. or at least 1300° C. or at least 1400° C. or at least 1450° C. Still, in at least one non-limiting embodiment, sintering may be conducted at a sintering temperature that is not greater than 1600° C., such as not greater than 1550° C., or not greater than 1500° C. or not greater than 1500° C. or not greater than 1400° C. or not greater than 1300° C. It will be appreciated that sintering may be conducted at a sintering temperature within a range including any of the above minimum and maximum temperatures.

Furthermore, it will be appreciated that sintering may be conducted for a particular time and under a particular atmosphere. For example, sintering may be conducted for at least 1 minute at ambient conditions at the sintering temperature, or even at least 4 minutes or at least 8 minutes, or at least 10 minutes or at least 15 minutes or at least 20 minutes or at least 30 minutes, or at least 40 minutes or at least 1 hour or at least 2 hours, or even at least about 3 hours. Still, in at least one non-limiting embodiment, the duration of sintering at the sintering temperature can include not greater than 4 hours or not greater than 3 hours or not greater than 2 hours or not greater than 1.5 hours. Furthermore, the atmosphere utilized during sintering may include an oxidizing atmosphere, a reducing atmosphere, or an inert atmosphere. According to one embodiment, the atmosphere can include air.

In at least one embodiment, the sintering process may include a two-step sintering process. For example, the sintering process may include a pre-sintering process, wherein the calcined material is treated at a first sintering temperature in a first atmosphere. The first sintering temperature can include any temperature within the range of sintering temperatures noted above. The atmosphere may include a standard atmosphere of air at standard atmospheric pressure in an open furnace (e.g., a tube furnace).

The process may include a second sintering process conducted after the first sintering process (i.e., the pre-sintering process). The second sintering process can be conducted at any of the sintering temperatures noted above. Moreover, in at least one embodiment, the second sintering process may be conducted in a controlled atmosphere, and more particularly, may be conducted using hot isostatic pressing. The second sintering process may use elevated pressures, such as at least 10,000 psi or at least 15,000 psi or at least 20,000 psi or at least 25,000 psi at the sintering temperature. Still, in at least one non-limiting embodiment, the pressure can be not greater than 100,000 psi or not greater than 80,000 psi or not greater than 50,000 psi or not greater than 40,000 psi. It will be appreciated that the pressure during sintering can be within a range including any of the pressures noted above.

Moreover, the atmosphere utilized during the second sintering process may include an oxidizing atmosphere, a reducing atmosphere or an inert atmosphere. In one particular embodiment, the atmosphere includes an inert gas, and may consist essentially of an inert gas (e.g., argon).

In accordance with an embodiment, after conducting the sintering process, the body of the finally-formed abrasive particle can have a density of at least about 95% theoretical density. In other instances, the body of the abrasive particle may have a greater density, such as at least about 96% or even at least about 97% theoretical density or at least 98% or at least 99% or even at least 99.5%.

In one embodiment, the density of the finally-formed particulate material can be at least 3.88 g/cm³, such as at least 3.90 g/cm³ or at least 3.92 g/cm³ or at least 3.94 g/cm³ or at least 3.96 g/cm³ or at least 3.98 g/cm³ or at least 4.00 g/cm³. Still, in another non-limiting embodiment, the density can be not greater than 4.50 g/cm³ or not greater than 4.40 g/cm³ or not greater than 4.30 g/cm³ or not greater than 4.20 g/cm³ or not greater than 4.15 g/cm³ or not greater than 4.12 g/cm³ or not greater than 4.10 g/cm³. It will be appreciated that the density can be within a range including any of the minimum and maximum values noted above.

After conducting the sintering process the finally-formed particulate material may have a specific surface area of not greater than 10 m²/g. In still other embodiments, the specific surface area of the particulate material maybe not greater than 9 m²/g, such as not greater than 8 m²/g or not greater than 7 m²/g or not greater than 5 m²/g or not greater than 1 m²/g or not greater than 0.5 m²/g or not greater than 0.2 m²/g. Still, the specific surface area of the particulate material may be at least about 0.01 m²/g, such as at least 0.05 m²/g or at least 0.08 m²/g or at least 0.1 m²/g or at least 1 m²/g or at least 2 m²/g or at least 3 m²/g. It will be appreciated that the specific surface area of the particulate material maybe be within a range including any of the above minimum and maximum values.

In yet another embodiment, the abrasive particles can have average particle size, which may be selected from a group of predetermined sieve sizes. For example, the body can have an average particle size of not greater than about 5 mm, such as not greater than about 3 mm, not greater than about 2 mm, not gather than about 1 mm, or even not greater than about 0.8 mm. Still, in another embodiment, the body may have an average particle size of at least about 0.1 μm. It will be appreciated that the body may have an average particle size within a range between any of the minimum and maximum values noted above. Particles for use in the abrasives industry are generally graded to a given particle size distribution before use. Such distributions typically have a range of particle sizes, from coarse particles to fine particles. In the abrasive art this range is sometimes referred to as a “coarse”, “control”, and “fine” fractions. Abrasive particles graded according to abrasive industry accepted grading standards specify the particle size distribution for each nominal grade within numerical limits. Such industry accepted grading standards (i.e., abrasive industry specified nominal grade) include those known as the American National Standards Institute, Inc. (ANSI) standards, Federation of European Producers of Abrasive Products (FEPA) standards, and Japanese Industrial Standard (JIS) standards.

Standards Institute, Inc. (ANSI) standards, Federation of European Producers of Abrasive Products (FEPA) standards, and Japanese Industrial Standard (JIS) standards. ANSI grade designations (i.e., specified nominal grades) include: ANSI 4, ANSI 6, ANSI 8, ANSI 16, ANSI 24, ANSI 36, ANSI 40, ANSI 50, ANSI 60, ANSI 80, ANSI 100, ANSI 120, ANSI 150, ANSI 180, ANSI 220, ANSI 240, ANSI 280, ANSI 320, ANSI 360, ANSI 400, and ANSI 600. FEPA grade designations include P8, P12, P16, P24, P36, P40, P50, P60, P80, P100, P120, P150, P180, P220, P320, P400, P500, P600, P800, P1000, and P1200. JIS grade designations include JIS8, JIS12, JIS16, JIS24, JIS36, JIS46, JIS54, JIS60, JIS80, JIS100, JIS150, JIS180, JIS220, JIS240, JIS280, JIS320, JIS360, JIS400, JIS600, JIS800, JIS1000, JIS1500, JIS2500, JIS4000, JIS6000, JIS8000, and JIS 10,000.

Alternatively, the shaped abrasive particles 20 can graded to a nominal screened grade using U.S.A. Standard Test Sieves conforming to ASTM E-1 1 “Standard Specification for Wire Cloth and Sieves for Testing Purposes.” ASTM E-1 1 prescribes the requirements for the design and construction of testing sieves using a medium of woven wire cloth mounted in a frame for the classification of materials according to a designated particle size. A typical designation may be represented as −18+20 meaning that the particles pass through a test sieve meeting ASTM E-1 1 specifications for the number 18 sieve and are retained on a test sieve meeting ASTM E-1 1 specifications for the number 20 sieve. In various embodiments, the particulate material can have a nominal screened grade comprising: −18+20, −20/+25, −25+30, −30+35, −35+40, −40+45, −45+50, −50+60, −60+70, −701+80, −80+100, −100+120, −120+140, −140+170, −170+200, −200+230, −230+270, −270+325, −325+400, −400+450, −450+500, or −500+635. Alternatively, a custom mesh size could be used such as −90+100. The body of the particulate material may be in the form of a shaped abrasive particle, as described in more detail herein.

In accordance with an embodiment, the abrasive particle can have a body including alumina. The alumina may be present as a first phase within the body, and may be the most prevalent phase within the body based on weight percent. According to one embodiment, the body includes at least 60 wt % alumina for the total weight of the body, such as at least 70 wt % alumina or at least 80 wt % alumina or at least 90 wt % alumina or at least 91 wt % alumina or at least 92 wt % alumina or at least 93 wt % alumina or at least 94 wt % alumina or at least 95 wt % alumina or at least 96 wt % alumina or at least 97 wt % alumina or at least 98 wt % alumina or at least 99 wt % alumina. In at least one embodiment, the body can consist essentially of alumina. In yet another non-limiting embodiment, the body can include not greater than 99 wt % alumina for the total weight of the body, such as not greater than 98.5 wt % alumina or not greater than 98 wt % alumina or not greater than 97 wt % alumina or not greater than 96 wt % alumina or not greater than 95 wt % alumina or not greater than 94 wt % alumina or not greater than 93 wt % alumina or not greater than 92 wt % alumina or not greater than 91 wt % alumina. It will be appreciated that the content of alumina in the body can be within a range including any of the minimum and maximum percentages noted above.

In certain instances, the body may be formed such that it is not greater than about 1 wt % of low-temperature alumina phases. As used herein, low temperature alumina phases can include transition phase aluminas, bauxites or hydrated alumina, including for example gibbsite, boehmite, diaspore, and mixtures containing such compounds and minerals. Certain low temperature alumina materials may also include some content of iron oxide. Moreover, low temperature alumina phases may include other minerals, such as goethite, hematite, kaolinite, and anastase. In particular instances, the particulate material can consist essentially of alpha alumina as the first phase and may be essentially free of low temperature alumina phases.

According to one embodiment, the body of the abrasive particle can further include a first intergranular phase. An intergranular phase is a phase that can be primarily disposed at the grain boundaries and between the grains (i.e., crystallites) of the first phase, which may include alumina. According to one embodiment, the first intergranular phase can be disposed entirely at the grain boundaries between the grains of the first phase.

The first intergranular phase can include an inorganic material, which can be a polycrystalline material. In one particular embodiment, the first intergranular phase can include magnesium. In another embodiment, the first intergranular phase can include oxygen, such that the first intergranular phase may be an oxygen containing compound. For example, the first intergranular phase can be a compound including magnesium and oxygen. In yet another embodiment, the first intergranular phase can include aluminum. For example, the first intergranular phase may include a combination of aluminum, magnesium and oxygen. According to one particular embodiment, the first intergranular phase can include spinel (MgAl₂O₄). In at least one embodiment, the first intergranular phase can consist essentially of spinel (MgAl₂O₄).

In at least one aspect, the body can include a particular content of the first intergranular phase that may facilitate improved performance of the body and abrasive particles. For example, the body can include at least 0.5 wt % of the first intergranular phase, such as at least 0.8 wt % or at least 1 wt % or at least 1.2 wt % or at least 1.5 wt % or at least 1.8 wt % or at least 2 wt % or at least 2.2 wt % or at least 2.5 wt % or at least 2.8 wt % or even at least 3 wt % or even 4 wt % or even at least 5 wt % or even at least 6 wt % or even at least 7 wt % or at least 8 wt % or at least 9 wt % or at least 10 wt % or at least 11 wt % or at least 12 wt % or at least 13 wt % or at least 14 wt % or at least 15 wt % of the first intergranular phase. Still, in at least one non-limiting embodiment, the body can include not greater than 30 wt % of the first intergranular phase, such as not greater than 25 wt % or not greater than 20 wt % or not greater than 18 wt % or not greater than 15 wt % or not greater than 12 wt % or not greater than 10 wt % or not greater than 9 wt % or not greater than 8 wt % or not greater than 7 wt % or not greater than 6 wt % or not greater than 5 wt % or not greater than 4 wt % or not greater than 3 wt % or not greater than 2 wt % or not greater than 1 wt % of the first intergranular phase. It will be appreciated that the body can include a content of the first intergranular phase within a range including any of the minimum and maximum percentages noted above.

The first intergranular phase may have an average crystalline size that is approximately the same as the average crystalline size of the first phase (e.g., alpha alumina crystallites). The relative difference in the average crystalline size of the first intergranular phase (CS1I) compared to the average crystalline size of the first phase including alumina (CS1) can be defined by a ratio CS1I/CS1 that can be not greater than 2, such as not greater than 1.9 or not greater than 1.8 or not greater than 1.7 or not greater than 1.6 or not greater than 1.5 or not greater than 1.4 or not greater than 1.3 or not greater than 1.2 or not greater than 1.1 or not greater than 1 or not greater than 0.9 or not greater than 0.8 or not greater than 0.7 or not greater than 0.6. Still, in one non-limiting embodiment, the ratio CS1I/CS1 can be at least 0.3 or at least 0.4 or at least 0.5 or at least 0.6 or at least 0.7 or at least 0.8 or at least 0.9 or at least 1 or at least 1.1 or at least 1.2 or at least 1.3 or at least 1.4 or at least 1.5 or at least 1.6 or at least 1.7. It will be appreciated that the ratio CS1I/CS1 can be within a range including any of the minimum and maximum values noted above.

According to another embodiment, the abrasive particle can have a body further including a second intergranular phase. The second intergranular phase can be distinct phase of material from the first intergranular phase. The second intergranular phase can be primarily disposed at the grain boundaries and between the grains (i.e., crystallites) of the first phase. According to one embodiment, the second intergranular phase can be disposed entirely at the grain boundaries between the grains of the first phase.

The second intergranular phase can include an inorganic material, which can be a polycrystalline material. In one particular embodiment, the second intergranular phase can include zirconium. In another embodiment, the second intergranular phase can include oxygen, such that the second intergranular phase may be an oxygen-containing compound. For example, the second intergranular phase can be a compound including zirconium and oxygen, such as zirconia (ZrO₂). In still other instances, the second intergranular phase may include at least one other species, including any of the additives noted above, such as magnesium, such that the second intergranular phase may include zirconium, magnesium, and oxygen. In still another embodiment, the second intergranular phase may include a combination of yttrium, zirconium, and oxygen. And in still another embodiment, the second intergranular phase can include a combination of zirconium, yttrium, magnesium, and oxygen. In yet another embodiment, the second intergranular phase may include aluminum. In at least one embodiment, the second intergranular phase may include a combination of aluminum, zirconium and oxygen. In certain embodiments including zirconia in the second intergranular phase, some content of hafnium may be included in the body, and more particularly, may be included in the second intergranular phase.

In such embodiments having a second intergranular phase including zirconia, the zirconia can have a tetragonal or monoclinic crystal structure. The crystal structure (e.g., tetragonal or monoclinic) of the zirconium containing phase may be determined in part by the presence of another additive, including for example yttrium or magnesium. In at least one embodiment, the second intergranular phase can include tetragonal zirconia and the abrasive particle can include some content of yttrium and/or magnesium.

In at least one aspect, the body can include a particular content of the second intergranular phase that may facilitate improved performance of the body and abrasive particles. For example, the body can include at least 0.5 wt % of the second intergranular phase, such as at least 0.8 wt % or at least 1 wt % or at least 1.2 wt % or at least 1.5 wt % or at least 1.8 wt % or at least 2 wt % or at least 2.2 wt % or at least 2.5 wt % or at least 2.8 wt % or at least 3 wt % of the second intergranular phase. Still, in at least one non-limiting embodiment, the body can include not greater than 30 wt % of the second intergranular phase, such as not greater than 25 wt % or not greater than 20 wt % or not greater than 18 wt % or not greater than 15 wt % or not greater than 12 wt % or not greater than 10 wt % not greater than 9 wt % or not greater than 8 wt % or not greater than 7 wt % or not greater than 6 wt % or not greater than 5 wt % or not greater than 4 wt % or not greater than 3 wt % or not greater than 2 wt % or not greater than 1 wt % of the second intergranular phase. It will be appreciated that the body can include a content of the second intergranular phase within a range including any of the minimum and maximum percentages noted above.

The second intergranular phase may have an average crystalline size that can be less than the average crystalline size of the first phase (e.g., alpha alumina crystallites). The relative difference in the average crystalline size of the second intergranular phase (CS2I) compared to the average crystalline size of the first phase including alumina (CS1) can be defined by a ratio CS2I/CS1 that can be not greater than 1, such as not greater than 0.9 or not greater than 0.8 or not greater than 0.7 or not greater than 0.6 or not greater than 0.5 or not greater than 0.4 or not greater than 0.3 or not greater than 0.2 or not greater than 0.1 or not greater than 0.05. Still, in one non-limiting embodiment, the ratio CS2I/CS1 can be at least 0.01 or at least 0.02 or at least 0.03 or at least 0.05 or at least 0.1 or at least 0.2 or at least 0.3 or at least 0.4 or at least 0.5 or at least 0.6 or at least 0.7 or at least 0.8 or at least 0.9. It will be appreciated that the ratio CS2I/CS1 can be within a range including any of the minimum and maximum values noted above.

As noted herein, in certain instances, the body may include a first intergranular phase, which can be present in a first content (C1) measured as the weight percent of the total weight of the body. The body may further include a second intergranular phase, which can be present in a second content (C2) measured as the weight percent of the total weight of the body. In certain instances, it may be advantageous to control the ratio of the contents of the first intergranular phase relative to the content of the second intergranular phase, which may facilitate improved properties and/or performance of the abrasive particle. For example, according to one embodiment, the body can have a greater content of the first intergranular phase compared to the content of the second intergranular phase, such that C1 is greater than C2. More particularly, the body can be formed such that the ratio (C1/C2) is at least 1.1, such as at least 1.5 or at least 2 or at least 3 or at least 5 or at least 8 or at least 10 or at least 15 or at least 20 or at least 30 or at least 40 or at least 50 or at least 60 or at least 70 or at least 80 or at least 90. Still, in one non-limiting embodiment, the ratio (C1/C2) can be not greater than 100 or not greater than 90 or not greater than 80 or not greater than 70 or not greater than 60 or not greater than 50 or not greater than 40 or not greater than 30 or not greater than 20 or not greater than 10 or not greater than 8 or not greater than 5 or not greater than 3 or not greater than 2 or not greater than 1.5. It will be appreciated that the ratio (C1/C2) can be within a range including any of the minimum and maximum values noted above.

In yet another embodiment, the body can have a greater content of the second intergranular phase compared to the content of the first intergranular phase, such that C2 is greater than C1. More particularly, the body can be formed such that the ratio (C2/C1) is at least 1.1, such as at least 1.5 or at least 2 or at least 3 or at least 5 or at least 8 or at least 10 or at least 15 or at least 20 or at least 30 or at least 40 or at least 50 or at least 60 or at least 70 or at least 80 or at least 90. Still, in one non-limiting embodiment, the ratio (C2/C1) can be not greater than 100 or not greater than 90 or not greater than 80 or not greater than 70 or not greater than 60 or not greater than 50 or not greater than 40 or not greater than 30 or not greater than 20 or not greater than 10 or not greater than 8 or not greater than 5 or not greater than 3 or not greater than 2 or not greater than 1.5. It will be appreciated that the ratio (C1/C2) can be within a range including any of the minimum and maximum values noted above.

In one particular embodiment, the body can be a polycrystalline material, and notably, the first phase can have a particularly small average crystallite size. For example, the first phase can have an average crystallite size that is not greater than 0.18 microns, such as not greater than 0.17 microns or not greater than 0.16 microns or not greater than 0.15 microns or not greater than 0.14 or not greater than 0.13 microns or not greater than 0.12 microns or not greater than 0.11 microns. Still, in at least one embodiment, the average crystallite size of the first phase, which may include alumina, can be at least 0.01 microns, such as at least 0.02 microns or at least 0.03 microns or at least 0.04 microns or at least 0.05 microns or at least 0.06 microns or at least 0.07 microns or at least 0.08 microns or even at least 0.09 microns. It will be appreciated that the average crystallite size of the first phase can be within a range including any of the minimum and maximum values noted above.

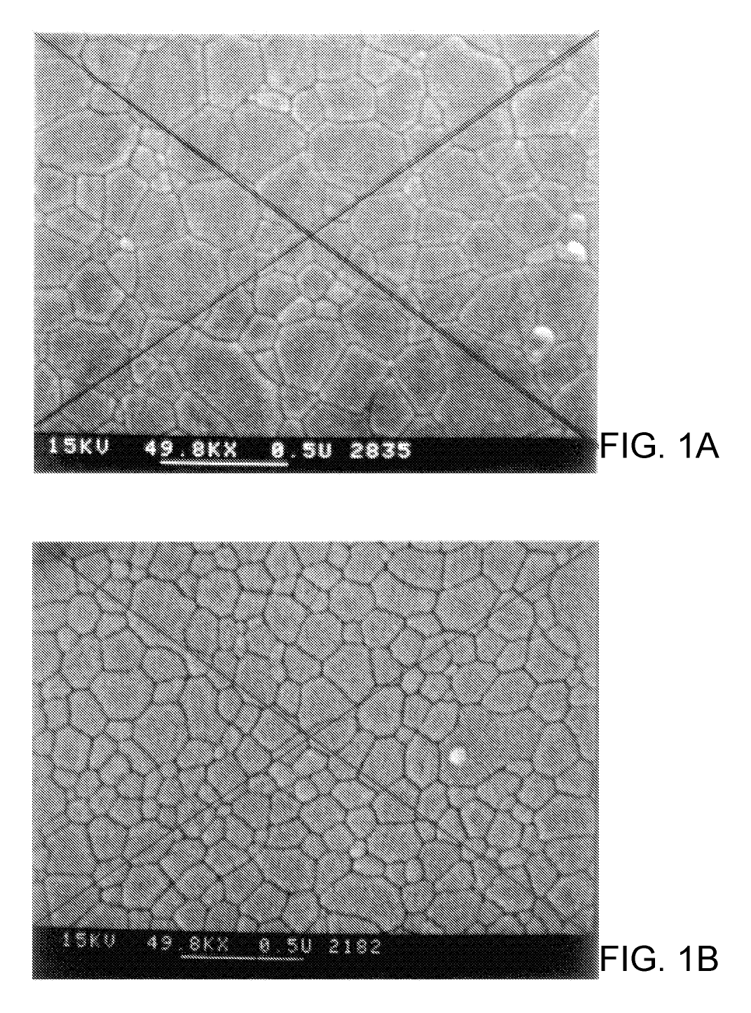

The average crystallite size can be measured based on the uncorrected intercept method using scanning electron microscope (SEM) photomicrographs. Samples of abrasive grains are prepared by making a bakelite mount in epoxy resin then polished with diamond polishing slurry using a Struers Tegramin 30 polishing unit. After polishing the epoxy is heated on a hot plate, the polished surface is then thermally etched for 5 minutes at 150° C. below sintering temperature. Individual grains (5-10 grits) are mounted on the SEM mount then gold coated for SEM preparation. SEM photomicrographs of three individual abrasive particles are taken at approximately 50,000× magnification, then the uncorrected crystallite size is calculated using the following steps: 1) draw diagonal lines from one corner to the opposite corner of the crystal structure view, excluding black data band at bottom of photo (see, for example, FIGS. 1A and 1B which are provided for illustration purposes); 2) measure the length of the diagonal lines as L1 and L2 to the nearest 0.1 centimeters; 3) count the number of grain boundaries intersected by each of the diagonal lines, (i.e., grain boundary intersections I1 and I2) and record this number for each of the diagonal lines, 4) determine a calculated bar number by measuring the length (in centimeters) of the micron bar (i.e., “bar length”) at the bottom of each photomicrograph or view screen, and divide the bar length (in microns) by the bar length (in centimeters); 5) add the total centimeters of the diagonal lines drawn on photomicrograph (L1+L2) to obtain a sum of the diagonal lengths; 6) add the numbers of grain boundary intersections for both diagonal lines (I1+I2) to obtain a sum of the grain boundary intersections; 7) divide the sum of the diagonal lengths (L1+L2) in centimeters by the sum of grain boundary intersections (I1+I2) and multiply this number by the calculated bar number. This process is completed at least three different times for three different, randomly selected samples to obtain an average crystallite size.

As an example of calculating the bar number, assume the bar length as provided in a photo is 0.4 microns. Using a ruler the measured bar length in centimeters is 2 cm. The bar length of 0.4 microns is divided by 2 cm and equals 0.2 um/cm as the calculated bar number. The average crystalline size is calculated by dividing the sum of the diagonal lengths (L1+L2) in centimeters by the sum of grain boundary intersections (I1+I2) and multiply this number by the calculated bar number.

According to one embodiment, the body of the abrasive particle can include a rare earth oxide. Examples of rare earth oxides can include yttrium oxide, cerium oxide, praseodymium oxide, samarium oxide, ytterbium oxide, neodymium oxide, lanthanum oxide, gadolinium oxide, dysprosium oxide, erbium oxide, precursors thereof, or the like. In a particular embodiment, the rare earth oxide can be selected from the group consisting of yttrium oxide, cerium oxide, praseodymium oxide, samarium oxide, ytterbium oxide, neodymium oxide, lanthanum oxide, gadolinium oxide, dysprosium oxide, erbium oxide, precursors thereof, and combinations thereof.

Still, in an alternative embodiment, the body of the abrasive particle can be essentially free of a rare earth oxide and/or iron oxide. It will be appreciated that the abrasive particles can include any of the rare earth oxides noted above. In another embodiment, the abrasive particles can be essentially free of a rare earth oxide and iron oxide. In a further embodiment the abrasives particles can include a phase containing a rare earth, a divalent cation and alumina which may be in the form of a magnetoplumbite structure. An example of a magnetoplumbite structure is MgLaAl₁₁O₁₉. Still, in another embodiment, the body can be essentially free of a aluminate phase, which may have a magnetoplumbite structure.

In certain embodiments, the body can be essentially free of certain material. For example, the body may be essentially free or free of a transition metal element, a lanthanoid element, an alkaline metal element, or a combination thereof. Notably, the body may be essentially free of yttrium, lanthanum, and a combination thereof. Reference herein to a body being essentially free of a particular material can include trace contents or impurity level contents of such materials that do not materially affect the properties of the material. For example, reference herein to a composition that is essentially free of a given material can include contents of said material of not greater than 0.1 wt % or even not greater than 0.05 wt % of said material for a total weight of the body.

According to another embodiment, the body may have a particular strength that may be considered particularly unique and unexpected given the microstructural features of the body. For example, the body can have an average strength of least 400 MPa, such as at least 410 MPa or at least 420 MPa or at least 430 MPa or at least 440 MPa or at least 450 MPa or at least 460 MPa or at least 470 MPa or at least 480 MPa or at least 490 MPa or at least 500 MPa or at least 510 MPa or at least 520 MPa or at least 530 MPa or at least 540 MPa or at least 550 MPa or at least 560 MPa or at least 570 MPa or at least 580 MPa or at least 590 MPa or at least 600 MPa. Still, in another non-limiting embodiment, the body can have an average strength of not greater than 900 MPa, such as not greater than 800 MPa or not greater than 700 MPa or not greater than 690 MPa or not greater than 680 MPa or not greater than 670 MPa or not greater than 660 MPa or not greater than 650 MPa or not greater than 640 MPa or not greater than 630 MPa or not greater than 620 MPa or not greater than 610 MPa or not greater than 600 MPa or not greater than 590 MPa or not greater than 580 MPa or not greater than 570 MPa or not greater than 560 MPa or not greater than 550 MPa or not greater than 540 MPa or not greater than 530 MPa or not greater than 520 MPa or not greater than 510 MPa or not greater than 500 MPa or not greater than 490 MPa or not greater than 480 MPa or not greater than 470 MPa. It will be appreciated that the strength can be within a range including any of the minimum and maximum values noted above.

The strength of the body may be measured via Hertzian indentation. In this method triangular shaped abrasive particles are adhered to a slotted aluminum SEM sample mounting stub. The equilateral triangular shaped abrasive particles have dimensions greater than 250 μm thick and 1300-1600 μm side length. The slots are approximately 250 μm deep and wide enough to accommodate the grains in a row. The grains are polished in an automatic polisher using a series of diamond pastes, with the finest paste of 1 μm to achieve a final mirror finish. At the final step, the polished grains are flat and flush with the aluminum surface. The height of the polished grains is therefore approximately 250 μm. The metal stub is fixed in a metal support holder and indented with a steel spherical indenter using an MTS universal test frame. The crosshead speed during the test is 2 μm/s. The steel ball used as the indenter is 3.2 mm in diameter. The maximum indentation load is the same for all grains, and the load at first fracture is determined from the load displacement curve as a load drop. After indentation, the grains are imaged optically to document the existence of the cracks and the crack pattern.

Using the first load drop as the pop-in load of the first ring crack, the Hertzian strength can be calculated. The Hertzian stress field is well defined and axisymmetrical. The stresses are compressive right under the indenter and tensile outside a region defined by the radius of the contact area. At low loads, the field is completely elastic. For a sphere of radius R and an applied normal load of P, the solutions for the stress field are readily found following the original Hertzian assumption that the contact is friction free.

The radius of the contact area a is given by:

$$\begin{matrix}{a}^{3} = \frac{3 PR}{4 {E}^{*}} & ( 1 ) \\ Where {E}^{*} = {( \frac{1 - {v}_{1}^{2}}{{E}_{1}} + \frac{1 - {v}_{2}^{2}}{{E}_{2}} )}^{- 1} & ( 2 )\end{matrix}$$

and E* is a combination of the Elastic modulus E and the Poisson's ratio v for the indenter and sample material, respectively.

The maximum contact pressure is given by:

$${p}_{0} = ( \frac{3 P}{2 π {a}^{2}} ) = {( \frac{6 {PE}^{{*}^{2}}}{{π}^{3} {R}^{2}} )}^{\frac{1}{3}} \qquad ( 3 )$$

The maximum shear stress is given by (assuming v=0.3): τ₁=0.31, p₀, at R=0 and z=0.48 a

The Hertzian strength is the maximum tensile stress at the onset of cracking and is calculated according to: σᵣ=1/3 (1-2 v) p₀, at R=a and z=0.

Using the first load drop as the load P in Eq. (3) the maximum tensile stress is calculated following the equation above, which is the value of the Hertzian strength for the specimen. In total, between 20 and 30 individual shaped abrasive particle samples are tested for each grit type, and a range of Hertzian fracture stress is obtained. Following Weibull analysis procedures (as outlined in ASTM C1239), a Weibull probability plot is generated, and the Weibull Characteristic strength (the scale value) and the Weibull modulus (the shape parameter) are calculated for the distribution using the maximum likelihood procedure.

The body may have a particular relative friability that is unique and unexpected given certain aspects of the microstructure. For example, the body can have a relative friability of least 106%, such as at least 107% or at least 108% or at least 109% or at least 110% or at least 111% or at least 112% or at least 115% or even at least 120%. In yet another non-limiting embodiment, the body can have a relative friability of not greater than 250%, such as not greater than 200% or not greater than 180% or not greater than 170% or not greater than 160% or not greater than 150% or not greater than 140% or not greater than 130%. It will be appreciated that the relative friability can be within a range including any of the minimum and maximum percentages noted above.

The relative friability is generally measured by milling a sample of the particles using tungsten carbide balls having an average diameter of ¾ inches for a given period of time, sieving the material resulting from the ball milling, and measuring the percent breakdown of the sample against that of a standard sample, which in the present embodiments, was a microcrystalline alumina sample having the same grit size.

Prior to ball milling, approximately 300 grams to 350 grams grains of a standard sample (e.g., microcrystalline alumina available as Cerpass HTB from Saint-Gobain Corporation) are sieved utilizing a set of screens placed on a Ro-Tap® sieve shaker (model RX-29) manufactured by WS Tyler Inc. The grit sizes of the screens are selected in accordance with ANSI Table 3, such that a determinate number and type of sieves are utilized above and below the target particle size. For example, for a target particle size of 80 grit, the process utilizes the following US Standard Sieve sizes: 1) 60; 2) 70; 3) 80; 4) 100; and 5) 120. The screens are stacked so that the grit sizes of the screens increase from top to bottom, and a pan is placed beneath the bottom screen to collect the grains that fall through all of the screens. The Ro-Tap® sieve shaker is run for 10 minutes at a rate of 287±10 oscillations per minute with the number of taps count being 150±10, and only the particles on the screen having the target grit size (referred to as target screen hereinafter) are collected as the target particle size sample. The same process is repeated to collect target particle size samples for the other test samples of material.

After sieving, a portion of each of the target particle size samples is subject to milling. An empty and clean mill container is placed on a roll mill. The speed of the roller is set to 305 rpm, and the speed of the mill container is set to 95 rpm. About 3500 grams of tungsten carbide balls having an average diameter of 3/4 inches are placed in the container. One hundred grams of the target particle size sample from the standard material sample are placed in the mill container with the balls. The container is closed and placed in the ball mill and run for a duration of 2 to 8 minutes. Ball milling is stopped, and the balls and the grains are sieved using the Ro-Tap® sieve shaker and the same screens as used to produce the target particle size sample. The rotary tapper is run for 5 minutes using the same conditions noted above to obtain the target particles size sample, and all the particles that fall through the target screen are collected and weighed. The percent breakdown of the standard sample is the mass of the grains that passed through the target screen divided by the original mass of the target particle size sample (i.e., 100 grams). If the percent breakdown is within the range of 48% to 52%, a second 100 grams of the target particle size sample is tested using exactly the same conditions as used for the first sample to determine the reproducibility of the test. If the second sample provides a percent breakdown within 48%-52%, the values are recorded. If the second sample does not provide a percent breakdown within 48% to 52%, the time of milling is adjusted, or another sample is obtained and the time of milling is adjusted until the percent breakdown falls within the range of 48%-52%. The test is repeated until two consecutive samples provide a percent breakdown within the range of 48%-52%, and these results are recorded.

The percent breakdown of a representative sample material (e.g., nanocrystalline alumina particles) is measured in the same manner as measuring the standard sample having the breakdown of 48% to 52%. The relative friability of the nanocrystalline alumina sample is the breakdown of the nanocrystalline sample relative to that of the standard microcrystalline sample.

According to another embodiment, the body may have a particular Vickers hardness that may be considered unique given the other micro structural features of the body. The Vickers hardness is measured by ASTM C1327. For example, the body can have an average strength of least 400 MPa, such as at least 410 MPa or at least 420 MPa or at least 430 MPa or at least 440 MPa or at least 450 MPa or at least 460 MPa or at least 470 MPa or at least 480 MPa or at least 490 MPa or at least 500 MPa or at least 510 MPa or at least 520 MPa or at least 530 MPa or at least 540 MPa or at least 550 MPa or at least 560 MPa or at least 570 MPa or at least 580 MPa or at least 590 MPa or at least 600 MPa. Still, in another non-limiting embodiment, the body can have an average strength of not greater than 900 MPa, such as not greater than 800 MPa or not greater than 700 MPa or not greater than 690 MPa or not greater than 680 MPa or not greater than 670 MPa or not greater than 660 MPa or not greater than 650 MPa or not greater than 640 MPa or not greater than 630 MPa or not greater than 620 MPa or not greater than 610 MPa or not greater than 600 MPa or not greater than 590 MPa or not greater than 580 MPa or not greater than 570 MPa or not greater than 560 MPa or not greater than 550 MPa or not greater than 540 MPa or not greater than 530 MPa or not greater than 520 MPa or not greater than 510 MPa or not greater than 500 MPa or not greater than 490 MPa or not greater than 480 MPa or not greater than 470 MPa. It will be appreciated that the strength can be within a range including any of the minimum and maximum values noted above.

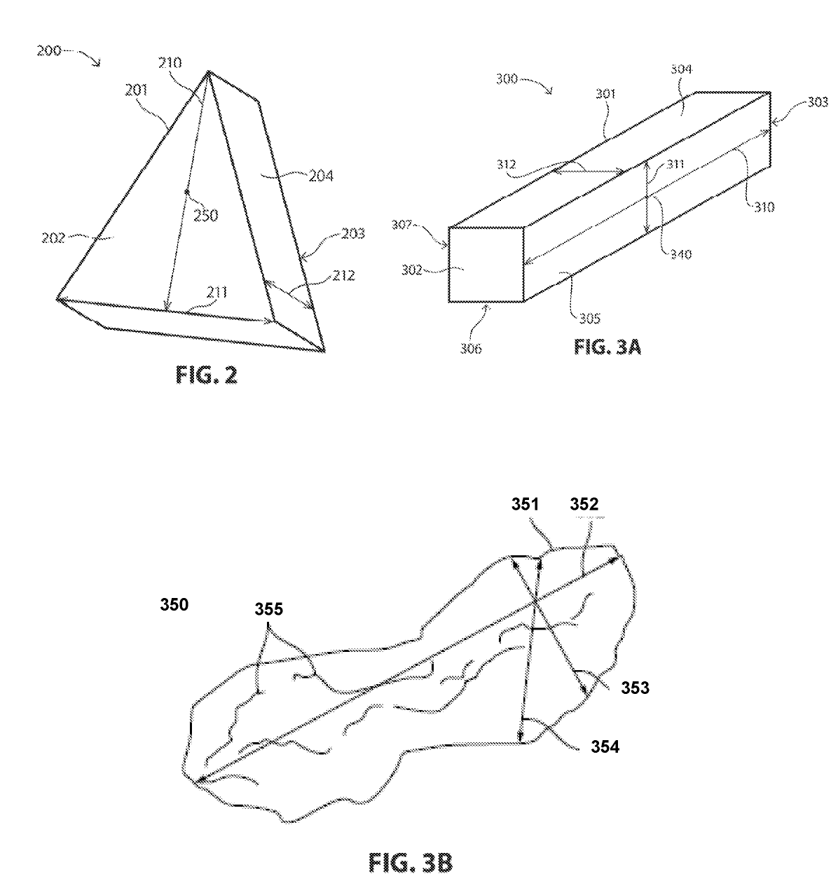

According to one embodiment, the abrasive particle can be a shaped abrasive particle. FIG. 2 includes a perspective view illustration of a shaped abrasive particle in accordance with an embodiment. The shaped abrasive particle 200 can include a body 201 including a major surface 202, a major surface 203, and a side surface 204 extending between the major surfaces 202 and 203. As illustrated in FIG. 2, the body 201 of the shaped abrasive particle 200 is a thin-shaped body, wherein the major surfaces 202 and 203 are larger than the side surface 204. Moreover, the body 201 can include a longitudinal axis 210 extending from a point to a base and through the midpoint 250 on the major surface 202. The longitudinal axis 210 can define the longest dimension of the major surface extending through the midpoint 250 of the major surface 202. The body 201 can further include a lateral axis 211 defining a width of the body 201 extending generally perpendicular to the longitudinal axis 210 on the same major surface 202. Finally, as illustrated, the body 201 can include a vertical axis 212, which in the context of thin shaped bodies can define a height (or thickness) of the body 201. For thin-shaped bodies, the length of the longitudinal axis 210 is equal to or greater than the vertical axis 212. As illustrated, the thickness 212 can extend along the side surface 204 between the major surfaces 202 and 203 and perpendicular to the plane defined by the longitudinal axis 210 and lateral axis 211. It will be appreciated that reference herein to length, width, and height of the abrasive particles may be referenced to average values taken from a suitable sampling size of abrasive particles of a batch.

The shaped abrasive particles can include any of the features of the abrasive particles of the embodiments herein. For example, the shaped abrasive particles can include a crystalline material, and more particularly, a polycrystalline material. Notably, the polycrystalline material can include abrasive grains. In one embodiment, the body of the abrasive particle, including for example, the body of a shaped abrasive particle can be essentially free of an organic material, including for example, a binder. In at least one embodiment, the abrasive particles can consist essentially of a polycrystalline material.

Some suitable materials for use as abrasive particles can include nitrides, oxides, carbides, borides, oxynitrides, oxyborides, diamond, carbon-containing materials, and a combination thereof. In particular instances, the abrasive particles can include an oxide compound or complex, such as aluminum oxide, zirconium oxide, titanium oxide, yttrium oxide, chromium oxide, strontium oxide, silicon oxide, magnesium oxide, rare-earth oxides, and a combination thereof. In one particular embodiment, the abrasive particles can include at least 95 wt % alumina for the total weight of the body. In at least one embodiment, the abrasive particles can consist essentially of alumina. Still, in certain instances, the abrasive particles can include not greater than 99.5wt % alumina for the total weight of the body. Moreover, in particular instances, the shaped abrasive particles can be formed from a seeded sol-gel. In at least one embodiment, the abrasive particles of the embodiments herein may be essentially free of iron, rare-earth oxides, and a combination thereof.

In accordance with certain embodiments, certain abrasive particles can be composite articles including at least two different types of grains within the body of the abrasive particle. It will be appreciated that different types of grains are grains having different compositions, different crystallite sizes, and/or different grit sizes with regard to each other. For example, the body of the abrasive particle can be formed such that is includes at least two different types of grains, wherein the two different types of grains can be nitrides, oxides, carbides, borides, oxynitrides, oxyborides, diamond, and a combination thereof.

In accordance with an embodiment, the shaped abrasive particles can have an average particle size, as measured by the largest dimension (i.e., length) of at least about 50 microns. In fact, the shaped abrasive particles can have an average particle size of at least about 100 micron, such as at least 150 microns, such as at least about 200 microns, at least about 300 microns, at least about 400 microns, at least about 500 microns, at least about 600 microns, at least about 700 microns, at least about 800 microns, or even at least about 900 microns. Still, the shaped abrasive particles of the embodiments herein can have an average particle size that is not greater than about 5 mm, such as not greater than about 3 mm, not greater than about 2 mm, or even not greater than about 1.5 mm. It will be appreciated that the shaped abrasive particles can have an average particle size within a range between any of the minimum and maximum values noted above.

FIG. 2 includes an illustration of a shaped abrasive particle having a two-dimensional shape as defined by the plane of the upper major surface 202 or major surface 203, which has a generally triangular two-dimensional shape. It will be appreciated that the shaped abrasive particles of the embodiments herein are not so limited and can include other two-dimensional shapes. For example, the shaped abrasive particles of the embodiment herein can include particles having a body with a two-dimensional shape as defined by a major surface of the body from the group of shapes including polygons, irregular polygons, irregular polygons including arcuate or curved sides or portions of sides, ellipsoids, numerals, Greek alphabet characters, Latin alphabet characters, Russian alphabet characters, Kanji characters, complex shapes having a combination of polygons shapes, star shapes, and a combination thereof.

FIG. 3A includes a perspective view illustration of a shaped abrasive particle according to an embodiment. Notably, the shaped abrasive particle 300 can include a body 301 including a surface 302 and a surface 303, which may be referred to as end surfaces 302 and 303. The body can further include surfaces 304, 305, 306, 307 extending between and coupled to the end surfaces 302 and 303. The shaped abrasive particle of FIG. 3A is an elongated shaped abrasive particle having a longitudinal axis 310 that extends along the surface 305 and through the midpoint 340 between the end surfaces 302 and 303. It will be appreciated that the surface 305 is selected for illustrating the longitudinal axis 310, because the body 301 has a generally square cross-sectional contour as defined by the end surfaces 302 and 303. As such, the surfaces 304, 305, 306, and 307 have approximately the same size relative to each other. However in the context of other elongated abrasive particles wherein the surfaces 302 and 303 define a different shape, for example a rectangular shape, wherein one of the surfaces 304, 305, 306, and 307 may be larger relative to the others, the largest surface of those surfaces defines the major surface and therefore the longitudinal axis would extend along the largest of those surfaces. As further illustrated, the body 301 can include a lateral axis 311 extending perpendicular to the longitudinal axis 310 within the same plane defined by the surface 305. As further illustrated, the body 301 can further include a vertical axis 312 defining a height of the abrasive particle, were in the vertical axis 312 extends in a direction perpendicular to the plane defined by the longitudinal axis 310 and lateral axis 311 of the surface 305.

It will be appreciated that like the thin shaped abrasive particle of FIG. 2, the elongated shaped abrasive particle of FIG. 3A can have various two-dimensional shapes such as those defined with respect to the shaped abrasive particle of FIG. 2. The two-dimensional shape of the body 301 can be defined by the shape of the perimeter of the end surfaces 302 and 303. The elongated shaped abrasive particle 300 can have any of the attributes of the shaped abrasive particles of the embodiments herein.

FIG. 3B includes an illustration of an elongated particle, which is not a shaped abrasive particle. Shaped abrasive particles may be formed through particular processes, including molding, printing, casting, extrusion, and the like. Shaped abrasive particles are formed such that the each particle has substantially the same arrangement of surfaces and edges relative to each other. For example, a group of shaped abrasive particles generally have the same arrangement and orientation and or two-dimensional shape of the surfaces and edges relative to each other. As such, the shaped abrasive particles have a high shaped fidelity and consistency in the arrangement of the surfaces and edges relative to each other. By contrast, non-shaped abrasive particles can be formed through different processes and have different shape attributes. For example, crushed grains are typically formed by a comminution process wherein a mass of material is formed and then crushed and sieved to obtain abrasive particles of a certain size. However, a non-shaped abrasive particle will have a generally random arrangement of the surfaces and edges, and generally will lack any recognizable two-dimensional or three dimensional shape in the arrangement of the surfaces and edges. Moreover, the non-shaped abrasive particles do not necessarily have a consistent shape with respect to each other and therefore have a significantly lower shape fidelity compared to shaped abrasive particles. The non-shaped abrasive particles generally are defined by a random arrangement of surfaces and edges with respect to each other.

As further illustrated in FIG. 3B, the elongated abrasive article can be a non-shaped abrasive particle having a body 351 and a longitudinal axis 352 defining the longest dimension of the particle, a lateral axis 353 extending perpendicular to the longitudinal axis 352 and defining a width of the particle. Furthermore, the elongated abrasive particle may have a height (or thickness) as defined by the vertical axis 354 which can extend generally perpendicular to a plane defined by the combination of the longitudinal axis 352 and lateral axis 353. As further illustrated, the body 351 of the elongated, non-shaped abrasive particle can have a generally random arrangement of edges 355 extending along the exterior surface of the body 351.

As will be appreciated, the elongated abrasive particle can have a length defined by longitudinal axis 352, a width defined by the lateral axis 353, and a vertical axis 354 defining a height. As will be appreciated, the body 351 can have a primary aspect ratio of length:width such that the length is greater than the width. Furthermore, the length of the body 351 can be greater than or equal to the height. Finally, the width of the body 351 can be greater than or equal to the height 354. In accordance with an embodiment, the primary aspect ratio of length:width can be at least 1.1:1, at least 1.2:1, at least 1.5:1, at least 1.8:1, at least 2:1, at least 3:1, at least 4:1, at least 5:1, at least 6:1, or even at least 10:1. In another non-limiting embodiment, the body 351 of the elongated shaped abrasive particle can have a primary aspect ratio of length:width of not greater than 100:1, not greater than 50:1, not greater than 10:1, not greater than 6:1, not greater than 5:1, not greater than 4:1, not greater than 3:1, or even not greater than 2:1. It will be appreciated that the primary aspect ratio of the body 351 can be with a range including any of the minimum and maximum ratios noted above.

Furthermore, the body 351 of the elongated abrasive particle 350 can include a secondary aspect ratio of width:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the secondary aspect ratio width:height of the body 351 can be not greater than 100:1, such as not greater than 50:1, not greater than 10:1, not greater than 8:1, not greater than 6:1, not greater than 5:1, not greater than 4:1, not greater than 3:1, or even not greater than 2:1. It will be appreciated the secondary aspect ratio of width:height can be with a range including any of the minimum and maximum ratios of above.

In another embodiment, the body 351 of the elongated abrasive particle 350 can have a tertiary aspect ratio of length:height that can be at least 1.1:1, such as at least 1.2:1, at least 1.5:1, at least 1.8:1, at least 2:1, at least 3:1, at least 4:1, at least 5:1, at least 8:1, or even at least 10:1. Still, in another non-limiting embodiment, the tertiary aspect ratio length:height of the body 351 can be not greater than 100:1, such as not greater than 50:1, not greater than 10:1, not greater than 8:1, not greater than 6:1, not greater than 5:1, not greater than 4:1, not greater than 3:1, It will be appreciated that the tertiary aspect ratio the body 351 can be with a range including any of the minimum and maximum ratios and above.

The elongated abrasive particle 350 can have certain attributes of the other abrasive particles described in the embodiments herein, including for example but not limited to, composition, microstructural features (e.g., average grain size), hardness, porosity, and the like.

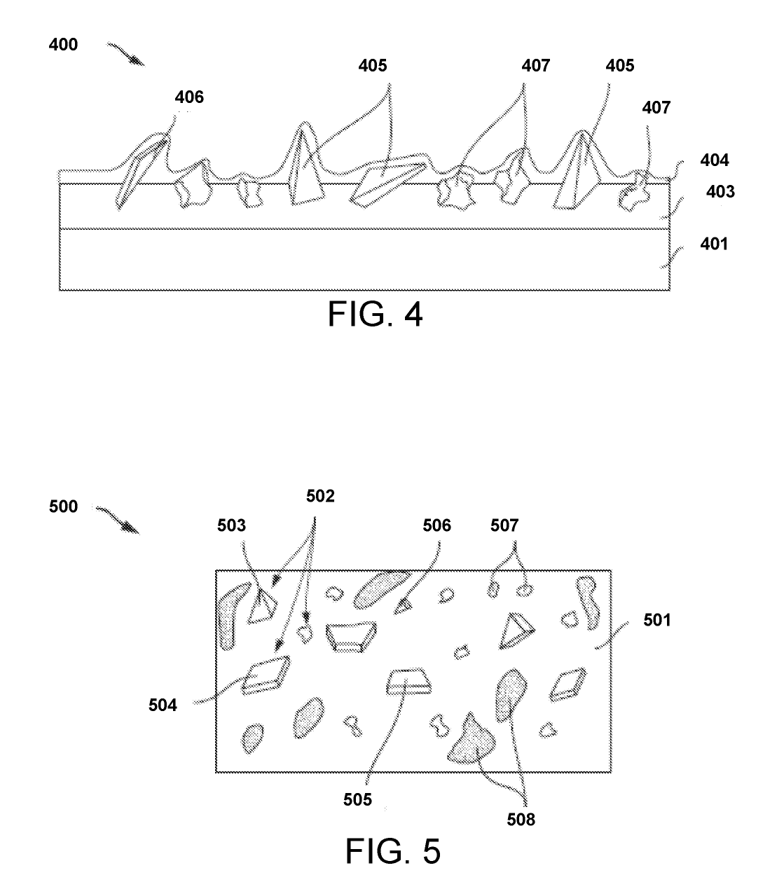

The abrasive particles of the embodiments herein may be incorporated into fixed abrasive articles, including but not limited to bonded abrasives, coated abrasives, non-woven abrasives, abrasive brushes, and the like. The abrasive particles may also be utilized as free abrasives, such as in slurries. FIG. 4 includes a cross-sectional illustration of a coated abrasive article incorporating the abrasive particles of the embodiments herein. As illustrated, the coated abrasive 400 can include a substrate 401 and a make coat 403 overlying a surface of the substrate 401. The coated abrasive 400 can further include a first type of abrasive particulate material 405 in the form of a first type of shaped abrasive particle, a second type of abrasive particulate material 406 in the form of a second type of shaped abrasive particle, and a third type of abrasive particulate material in the form of diluent abrasive particles, which may not necessarily be shaped abrasive particles, and having a random shape. The coated abrasive 400 may further include size coat 404 overlying and bonded to the abrasive particulate materials 405, 406, 407, and the make coat 404. The abrasive particles of the embodiments herein can be shaped abrasive particles or irregular abrasive particles and can be incorporated into any fixed abrasive or free abrasive.

According to one embodiment, the substrate 401 can include an organic material, inorganic material, and a combination thereof. In certain instances, the substrate 401 can include a woven material. However, the substrate 401 may be made of a non-woven material. Particularly suitable substrate materials can include organic materials, including polymers, and particularly, polyester, polyurethane, polypropylene, polyimides such as KAPTON from DuPont, paper. Some suitable inorganic materials can include metals, metal alloys, and particularly, foils of copper, aluminum, steel, and a combination thereof.

The make coat 403 can be applied to the surface of the substrate 401 in a single process, or alternatively, the abrasive particulate materials 405, 406, 407 can be combined with a make coat 403 material and the combination of the make coat 403 and abrasive particulate materials 405-407 can be applied as a mixture to the surface of the substrate 401. In certain instances, controlled deposition or placement of the abrasive particles in the make coat may be better suited by separating the processes of applying the make coat 403 from the deposition of the abrasive particulate materials 405-407 in the make coat 403. Still, it is contemplated that such processes may be combined. Suitable materials of the make coat 403 can include organic materials, particularly polymeric materials, including for example, polyesters, epoxy resins, polyurethanes, polyamides, polyacrylates, polymethacrylates, polyvinylchlorides, polyethylene, polysiloxane, silicones, cellulose acetates, nitrocellulose, natural rubber, starch, shellac, and mixtures thereof. In one embodiment, the make coat 403 can include a polyester resin. The coated substrate can then be heated in order to cure the resin and the abrasive particulate material to the substrate. In general, the coated substrate 401 can be heated to a temperature of between about 100 ° C. to less than about 250 ° C. during this curing process.

The abrasive particulate materials 405, 406, and 407 can include different types of shaped abrasive particles according to embodiments herein. The different types of shaped abrasive particles can differ from each other in composition, two-dimensional shape, three-dimensional shape, size, and a combination thereof as described in the embodiments herein. As illustrated, the coated abrasive 400 can include a first type of shaped abrasive particle 405 having a generally triangular two-dimensional shape and a second type of shaped abrasive particle 406 having a quadrilateral two-dimensional shape. The coated abrasive 400 can include different amounts of the first type and second type of shaped abrasive particles 405 and 406. It will be appreciated that the coated abrasive may not necessarily include different types of shaped abrasive particles, and can consist essentially of a single type of abrasive particle or a blend of different types of abrasive particles, some of which may be shaped abrasive particles or irregular abrasive particles (e.g., crushed). As will be appreciated, the shaped abrasive particles of the embodiments herein can be incorporated into various fixed abrasives (e.g., bonded abrasives, coated abrasive, non-woven abrasives, thin wheels, cut-off wheels, reinforced abrasive articles, and the like), including in the form of blends, which may include different types of shaped abrasive particles, shaped abrasive particles with diluent particles, and the like. Moreover, according to certain embodiments, batch of particulate material may be incorporated into the fixed abrasive article in a predetermined orientation, wherein each of the shaped abrasive particles can have a predetermined orientation relative to each other and relative to a portion of the abrasive article (e.g., the backing of a coated abrasive).

The abrasive particles 407 can be diluent particles different than the first and second types of shaped abrasive particles 405 and 406. For example, the diluent particles can differ from the first and second types of shaped abrasive particles 405 and 406 in composition, two-dimensional shape, three-dimensional shape, size, and a combination thereof. For example, the abrasive particles 407 can represent conventional, crushed abrasive grit having random shapes. The abrasive particles 407 may have a median particle size less than the median particle size of the first and second types of shaped abrasive particles 405 and 506.

After sufficiently forming the make coat 403 with the abrasive particulate materials 405, 406, 407 contained therein, the size coat 404 can be formed to overlie and bond the abrasive particulate material 405 in place. The size coat 404 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

FIG. 5 includes an illustration of a bonded abrasive article incorporating the abrasive particulate material in accordance with an embodiment. As illustrated, the bonded abrasive 500 can include a bond material 501, abrasive particulate material 502 contained in the bond material, and porosity 508 within the bond material 501. In particular instances, the bond material 501 can include an organic material, inorganic material, and a combination thereof. Suitable organic materials can include polymers, such as epoxies, resins, thermosets, thermoplastics, polyimides, polyamides, and a combination thereof. Certain suitable inorganic materials can include metals, metal alloys, vitreous phase materials, crystalline phase materials, ceramics, and a combination thereof.

The abrasive particulate material 502 of the bonded abrasive 500 can include different types of shaped abrasive particles 503, 504, 505, and 506, which can have any of the features of different types of shaped abrasive particles as described in the embodiments herein. Notably, the different types of shaped abrasive particles 503, 504, 505, and 506 can differ from each other in composition, two-dimensional shape, three-dimensional shape, size, and a combination thereof as described in the embodiments herein.

The bonded abrasive 500 can include a type of abrasive particulate material 507 representing diluent abrasive particles, which can differ from the different types of shaped abrasive particles 503, 504, 505, and 506 in composition, two-dimensional shape, three-dimensional shape, size, and a combination thereof.

The porosity 508 of the bonded abrasive 500 can be open porosity, closed porosity, and a combination thereof. The porosity 508 may be present in a majority amount (vol %) based on the total volume of the body of the bonded abrasive 500. Alternatively, the porosity 508 can be present in a minor amount (vol %) based on the total volume of the body of the bonded abrasive 500. The bond material 501 may be present in a majority amount (vol %) based on the total volume of the body of the bonded abrasive 500. Alternatively, the bond material 501 can be present in a minor amount (vol %) based on the total volume of the body of the bonded abrasive 500. Additionally, abrasive particulate material 502 can be present in a majority amount (vol %) based on the total volume of the body of the bonded abrasive 500. Alternatively, the abrasive particulate material 502 can be present in a minor amount (vol %) based on the total volume of the body of the bonded abrasive 500.

### Embodiments

Embodiment 1. An abrasive particle comprising:
a body including alumina, the alumina including a plurality of crystallites having an average crystallite size of not greater than 0.18 microns, and wherein the body has at least one of an average strength of not greater than 1000 MPa or a relative friability of at least 105%.

Embodiment 2. An abrasive particle comprising:
a body including alumina and at least one intergranular phase, the alumina including a plurality of crystallites having an average crystallite size of not greater than 0.18 microns, and wherein the body has at least one of an average strength of not greater than 1000 MPa or a relative friability of at least 105%.

Embodiment 3. An abrasive particle comprising:
a body including:
a polycrystalline material including a plurality of crystallites comprising alumina, wherein the crystallites have an average crystallite size of not greater than 0.18 microns;
a first intergranular phase comprising magnesium;
a second intergranular phase comprising zirconia; and
at least one of an average strength of not greater than 1000 MPa or a relative friability of at least 105%.

Embodiment 4. An abrasive particle comprising:
a body including:
a polycrystalline material including a plurality of crystallites comprising alumina, wherein the crystallites have an average crystallite size of not greater than 0.12 microns;
a first intergranular phase comprising magnesium;
a second intergranular phase comprising zirconia; and
at least one of an average strength of not greater than 1000 MPa, a relative friability of at least 105%, and a theoretical density of at least 98.5%.

Embodiment 5. An abrasive particle comprising:
a body including alumina, the alumina including a plurality of crystallites having an average crystallite size of not greater than 0.12 microns, and wherein the body has at least one of an average strength of not greater than 1000 MPa, a relative friability of at least 105%, or a theoretical density of at least 98.5%.

Embodiment 6. The abrasive particle of any one of embodiments 1, 2, 3, 4, and 5, wherein the body comprises a majority content of alumina by weight.

Embodiment 7. The abrasive particle of any one of embodiments 1, 2, and 3, 4, and 5, wherein the body includes at least 60 wt % alumina or at least 70 wt % alumina or at least 80 wt % alumina or at least 90 wt % alumina or at least 91 wt % alumina or at least 92 wt % alumina or at least 93 wt % alumina or at least 94 wt % alumina or at least 95 wt % alumina or at least 96 wt % alumina or at least 97 wt % alumina or at least 98 wt % alumina or at least 99 wt % alumina or wherein the body consists essentially of alumina.

Embodiment 8. The abrasive particle of any one of embodiments 1, 2, and 3, 4, and 5, wherein the body includes not greater than 99 wt % alumina or not greater than 98 wt % alumina or not greater than 97 wt % alumina or not greater than 96 wt % alumina or not greater than 95 wt % alumina or not greater than 94 wt % alumina or not greater than 93 wt % alumina or not greater than 92 wt % alumina or not greater than 91 wt % alumina.

Embodiment 9. The abrasive particle of any one of embodiments 1,2, and 5, wherein the body further comprises a first intergranular phase comprising magnesium.

Embodiment 10. The abrasive particle of any one of embodiments 3, 4,and 9, wherein the first intergranular phase further comprises oxygen.

Embodiment 11. The abrasive particle of any one of embodiments 3, 4,and 9, wherein the first intergranular phase further comprises aluminum.

Embodiment 12. The abrasive particle of any one of embodiments 3, 4,and 9, wherein the first intergranular phase comprises spinel (MgAl2O4).

Embodiment 13. The abrasive particle of any one of embodiments 3, 4,and 9, wherein the first intergranular phase comprises a polycrystalline material.

Embodiment 14. The abrasive particle of any one of embodiments 3, 4,and 9, wherein the body includes at least 0.5 wt % of the first intergranular phase or at least 0.8 wt % of the first intergranular phase or at least 1 wt % of the first intergranular phase or at least 1.2 wt % of the first intergranular phase or at least 1.5 wt % of the first intergranular phase or at least 1.8 wt % of the first intergranular phase or at least 2 wt % of the first intergranular phase or at least 2.2 wt % of the first intergranular phase or at least 2.5 wt % of the first intergranular phase or at least 2.8 wt % of the first intergranular phase or at least 3 wt % of the first intergranular phase or at least 4 wt % of the first intergranular phase or at least 5 wt % of the first intergranular phase or at least 6 wt % of the first intergranular phase or at least 7 wt % of the first intergranular phase or at least 8 wt % of the first intergranular phase or at least 9 wt % of the first intergranular phase

Embodiment 15. The abrasive particle of any one of embodiments 3, 4,and 9, wherein the body includes not greater than 30 wt % of the first intergranular phase or not greater than 25 wt % or not greater than 20 wt % or not greater than 18 wt % or not greater than 15 wt % or not greater than 12 wt % or not greater than 10 wt % or not greater than 9 wt % of the first intergranular phase or not greater than 8 wt % of the first intergranular phase or not greater than 7 wt % of the first intergranular phase or not greater than 6 wt % of the first intergranular phase or not greater than 5 wt % of the first intergranular phase or not greater than 4 wt % of the first intergranular phase or not greater than 3 wt % of the first intergranular phase or not greater than 2 wt % of the first intergranular phase or not greater than 1 wt % of the first intergranular phase.

Embodiment 16. The abrasive particle of any one of embodiments 1, 2, and 5, wherein the body further comprises a second intergranular phase comprising zirconium.

Embodiment 17. The abrasive particle of any one of embodiments 3, 4, and 16, wherein the second intergranular phase further comprises oxygen.

Embodiment 18. The abrasive particle of any one of embodiments 3, 4, and 16, wherein the second intergranular phase comprises zirconia (ZrO2).

Embodiment 19. The abrasive particle of any one of embodiments 3, 4, and 16, wherein the second intergranular phase comprises a polycrystalline material.

Embodiment 20. The abrasive particle of any one of embodiments 3, 4, and 16, wherein the body includes at least 0.5 wt % of the second intergranular phase or at least 0.8 wt % of the second intergranular phase or at least 1 wt % of the second intergranular phase or at least 1.2 wt % of the second intergranular phase or at least 1.5 wt % of the second intergranular phase or at least 1.8 wt % of the second intergranular phase or at least 2 wt % of the second intergranular phase or at least 2.2 wt % of the second intergranular phase or at least 2.5 wt % of the second intergranular phase or at least 2.8 wt % of the second intergranular phase or at least 3 wt % of the second intergranular phase or at least 4 wt % of the second intergranular phase or at least 5 wt % of the second intergranular phase or at least 6 wt % of the second intergranular phase or at least 7 wt % of the second intergranular phase or at least 8 wt % of the second intergranular phase or at least 9 wt % of the second intergranular phase.

Embodiment 21. The abrasive particle of any one of embodiments 3, 4, and 16, wherein the body includes not greater than 30 wt % of the second intergranular phase or not greater than 25 wt % or not greater than 20 wt % or not greater than 18 wt % or not greater than 15 wt % or not greater than 12 wt % or not greater than 10 wt % or not greater than 9 wt % of the second intergranular phase or not greater than 8 wt % of the second intergranular phase or not greater than 7 wt % of the second intergranular phase or not greater than 6 wt % of the second intergranular phase or not greater than 5 wt % of the second intergranular phase or not greater than 4 wt % of the second intergranular phase or not greater than 3 wt % of the second intergranular phase or not greater than 2 wt % of the second intergranular phase or not greater than 1 wt % of the second intergranular phase.

Embodiment 22. The abrasive particle of embodiment 16, wherein the body further comprises a first intergranular phase.

Embodiment 23. The abrasive particle of embodiment 22, wherein the first intergranular phase is present in first content (C1) measured as weight percent for a total weight of the body and the second intergranular phase is present in a second content (C2) measured as weight percent for a total weight of the body and the first content is different than the second content.

Embodiment 24. The abrasive particle of embodiment 22, wherein C1 is greater than C2.

Embodiment 25. The abrasive particle of embodiment 24, wherein the body comprises a ratio C1/C2 of not greater than 100 or not greater than 90 or not greater than 80 or not greater than 70 or not greater than 60 or not greater than 50 or not greater than 40 or not greater than 30 or not greater than 20 or not greater than 10 or not greater than 8 or not greater than 5 or not greater than 3 or not greater than 2 or not greater than 1.5.

Embodiment 26. The abrasive particle of embodiment 24, wherein the body comprises a ratio C1/C2 of at least 1.1 or at least 1.5 or at least 2 or at least 3 or at least 5 or at least 8 or at least 10 or at least 15 or at least 20 or at least 30 or at least 40 or at least 50 or at least 60 or at least 70 or at least 80 or at least 90.

Embodiment 27. The abrasive particle of embodiment 22, wherein C2 is greater than C1.

Embodiment 28. The abrasive particle of embodiment 27, wherein the body comprises a ratio C2/C1 of not greater than 100 or not greater than 90 or not greater than 80 or not greater than 70 or not greater than 60 or not greater than 50 or not greater than 40 or not greater than 30 or not greater than 20 or not greater than 10 or not greater than 8 or not greater than 5 or not greater than 3 or not greater than 2 or not greater than 1.5.

Embodiment 29. The abrasive particle of embodiment 22, wherein the body comprises a ratio C2/C1 of at least 1.1 or at least 1.5 or at least 2 or at least 3 or at least 5 or at least 8 or at least 10 or at least 15 or at least 20 or at least 30 or at least 40 or at least 50 or at least 60 or at least 70 or at least 80 or at least 90.

Embodiment 30. The abrasive particle of any one of embodiments 1, 2, and 3, wherein the average crystallite size is not greater than 0.17 microns or not greater than 0.16 microns or not greater than 0.15 microns or not greater than 0.14 or not greater than 0.13 microns or not greater than 0.12 microns or not greater than 0.11 microns.

Embodiment 31. The abrasive particle of any one of embodiments 4, and 5, wherein the average crystallite size is not greater than 0.11 microns or not greater than 0.1 microns or not greater than 0.09 microns.

Embodiment 32. The abrasive particle of any one of embodiments 1, 2, 3, 4, and 5, wherein the average crystallite size is at least 0.01 microns or at least 0.02 microns or at least 0.03 microns or at least 0.04 microns or at least 0.05 microns or at least 0.06 microns or at least 0.07 microns or at least 0.08 microns or at least 0.09 microns.

Embodiment 33. The abrasive particle of any one of embodiments 1, 2, 3, 4, and 5, wherein the body is essentially free of at least one of a transition metal element, a lanthanoid element, an alkaline metal element, or a combination thereof.

Embodiment 34. The abrasive particle of any one of embodiments 1, 2, 3, 4, and 5, wherein the body has an average strength of least 400 MPa or at least 410 MPa or at least 420 MPa or at least 430 MPa or at least 440 MPa or at least 450 MPa or at least 460 MPa or at least 470 MPa or at least 480 MPa or at least 490 MPa or at least 500 MPa or at least 510 MPa or at least 520 MPa or at least 530 MPa or at least 540 MPa or at least 550 MPa or at least 560 MPa or at least 570 MPa or at least 580 MPa or at least 590 MPa or at least 600 MPa.

Embodiment 35. The abrasive particle of any one of embodiments 1, 2, 3, 4, and 5, wherein the body has an average strength of not greater than 900 MPa or not greater than 600 MPa or not greater than 700 MPa or not greater than 690 MPa or not greater than 680 MPa or not greater than 670 MPa or not greater than 660 MPa or not greater than 650 MPa or not greater than 640 MPa or not greater than 630 MPa or not greater than 620 MPa or not greater than 610 MPa or not greater than 600 MPa or not greater than 590 MPa or not greater than 580 MPa or not greater than 570 MPa or not greater than 560 MPa or not greater than 550 MPa or not greater than 540 MPa or not greater than 530 MPa or not greater than 520 MPa or not greater than 510 MPa or not greater than 500 MPa or not greater than 490 MPa or not greater than 480 MPa or not greater than 470 MPa.

Embodiment 36. The abrasive particle of any one of embodiments 1, 2, 3, 4, and 5, wherein the body has a relative friability of least 106% or at least 107% or at least 108% or at least 109% or at least 110% or at least 111% or at least 112% or at least 115% or at least 120%.

Embodiment 37. The abrasive particle of any one of embodiments 1, 2, 3, 4, and 5, wherein the body has a relative friability of not greater than 250% or not greater than 200% or not greater than 180% or not greater than 170% or not greater than 160% or not greater than 150% or not greater than 140% or not greater than 130%.

Embodiment 38. The abrasive particle of any one of embodiments 1, 2, and 3, wherein the body has a theoretical density of at least 95% or at least 96% or at least 97% or at least 98% or at least 99% or at least 99.5%.

Embodiment 39. The abrasive particle of any one of embodiments 4 and 5, wherein the body has a theoretical density of at least 99% or at least 99.5%.

Embodiment 40. The abrasive particle of any one of embodiments 1, 2, and 3, wherein the body is a shaped abrasive particle.

Embodiment 41. A shaped abrasive particle having at least one surface including a plurality of abrasive particles bonded thereto, and wherein at least one abrasive particle of the plurality of abrasive particles is the abrasive particle of any one of embodiments 1, 2, 3, 4, and 5.

### EXAMPLE

A sample of abrasive particles were made by first obtaining 500 g of boehmite, commercially available from Sasol Corporation as Disperal. The boehmite had an average particle size of approximately 100 nm and a specific surface area of 200 m²/g. The boehmite was made into a slurry by adding 800 g of deionized water. The mixture was mixed in a Jaygo mixer and 12 g (2.4 wt % based on the weight of boehmite) of alpha alumina seeds were added to the mixture. The alpha alumina seeds were added as a mixture including 20 wt % seeds and 80 wt % deionized water. The alpha alumina seeds had a specific surface area of 75 m²/g and an average particle size of approximately 50-100 nm. Nitric acid was also added to the mixture in a ratio (by weight) of 0.035, calculated by nitric acid/boehmite (i.e., 3.5% nitric acid based on boehmite).

The mixture was then dried overnight at 95° C. in a standard atmosphere. After drying, the mixture was crushed and sized using standard US Standard sieves of −25 mesh +35 mesh, providing a dried particulate having approximately a 54 grit size after sintering.

The dried particles were then calcined at a calcination temperature of approximately 1000° C. for 10 minutes in a rotary tube furnace of standard atmospheric pressure and an atmosphere of air.

After calcining, the calcined material was impregnated with an aqueous solution containing zirconium and magnesium. The magnesium was obtained available from Sigma-Aldrich as is magnesium nitrate hexahydrate, puriss p.a., ACS reagent, 98.0-102.0% (KT). For 100 grams of the calcined grains an impregnation solution was prepared. An amount of 40.8 grams of an aqueous solution was formed, which included 20 wt % of ZrO₂ and 15.3 wt % of HNO₃. Then a magnesium nitrate solution was added to the solution containing the nitric acid and zirconium. The magnesium nitrate solution was made from 13.9 grams of magnesium nitrate in 12.4 grams of water. The magnesium nitrate solution was stirred until the magnesium nitrate was dissolved and the solution was clear. The magnesium nitrate solution was added to the solution containing the dissolved ZBC to create an impregnation solution. The ZBC is commercially available as SN-ZBC from Saint-Gobain ZirPro. The impregnation solution was added to the calcined grains while stirring. The impregnated grains were dried at 95° C. overnight (i.e., 10-12 hours) in a standard atmosphere.

After impregnating the material, the impregnated materials were sintered using a two-step sintering process. First, the impregnated materials were pre-sintered at 1265° C. for 10 minutes in a tube furnace using standard atmospheric pressure and an atmosphere of air. The pre-sintered particles were cooled and transferred to a chamber for a second sintering process using hot isostatic pressing (HIPing). The hot isostatic pressing was conducted using a heating ramp from room temperature to 1200 C with a ramp rate of 10 C/min. While heating, the pressure was increased from standard atmospheric pressure to approximately 29,500 psi at a ramp rate of approximately 250 psi/min. The particles were held at the maximum temperature and pressure for 1 hour. After 1 hour, the pressure was decreased at a rate of approximately 150 psi/min and the chamber was allowed to cool naturally upon turning off the power to the heating elements. The furnace atmosphere during the HIPing process was argon.

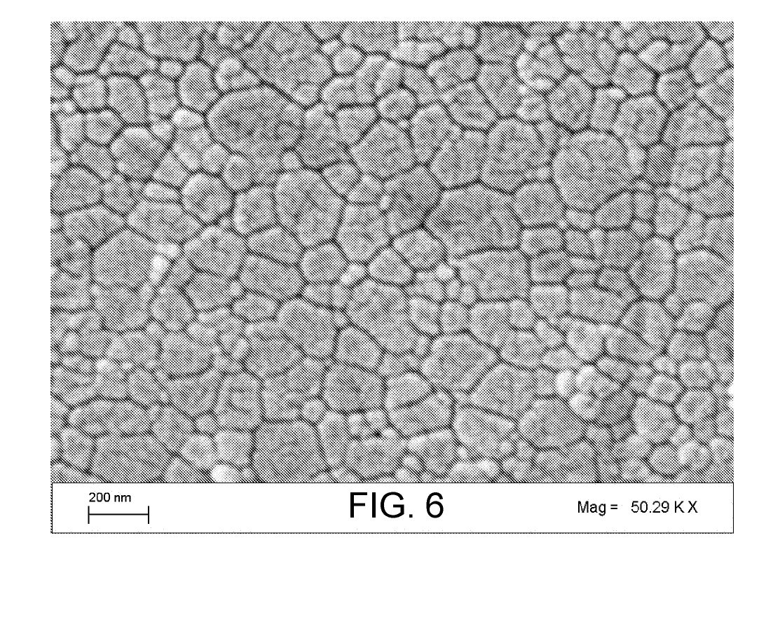

FIG. 6 includes an image of a portion of the abrasive particles formed according to Example 1. The resulting abrasive particles included a polycrystalline material having a average crystallite size of the first phase of alpha alumina of approximately 0.11 microns, approximately 7 wt % spinel (MgAl₂O₄) as the first intergranular phase and 6.5 wt % of the second intergranular phase including zirconium oxide. The abrasive particles had a relative friability of 124% compared to the standard and conventional sample (thus having a friability of 100%) of Cerpass HTB commercially available from Saint-Gobain Corporation.

The standard and conventional sample had 2.4 wt % of zirconia, 1 wt % magnesium, and an average crystallite size of the alumina phase of approximately 0.2 microns.

The mixture used to form the abrasive particles of Sample 1 was also used to form shaped abrasive particles having an equilateral triangular two-dimensional shape having a length of a side of approximately 1500 μm and a thickness (or height between major surfaces) of approximately 265 microns. Prior to calcining, the mixture was deposited into a production tool having triangular shaped openings, which were coated in oil. The mixture was deposited in the openings, the excess was wiped off using a doctor blade, and the mixture was dried in the openings according to the conditions above. Once dried, the precursor shaped abrasive particles were removed from the production tool, calcined, impregnated, and sintered according to the conditions above.

The representative shaped abrasive particles had an average strength of approximately 587 MPa, compared to the standard and conventional sample, which had an average strength of 600 MPa.

The foregoing embodiments are directed to abrasive particles having a unique combination of microstructure and properties, such as strength and friability. While

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

1. An abrasive particle comprising:
a body including alumina, the alumina including a plurality of crystallites having an average crystallite size of not greater than 0.18 microns, and wherein the body has at least one of an average strength of not greater than 1000 MPa or a relative friability of at least 105%.

2. An abrasive particle comprising:
a body including alumina and at least one intergranular phase, the alumina including a plurality of crystallites having an average crystallite size of not greater than 0.18 microns, and wherein the body has at least one of an average strength of not greater than 1000 MPa or a relative friability of at least 105%.

3. An abrasive particle comprising:
a body including:
a polycrystalline material including a plurality of crystallites comprising alumina, wherein the crystallites have an average crystallite size of not greater than 0.18 microns;
a first intergranular phase comprising magnesium;
a second intergranular phase comprising zirconia; and
at least one of an average strength of not greater than 1000 MPa or a relative friability of at least 105%.

4-5. (canceled)

6. The abrasive particle of claim 1, wherein the body includes at least 90 wt % and not greater than 99 wt % alumina for the total weight of the body.

7. The abrasive particle of claim 1, wherein the body includes alumina or not greater than 98 wt % alumina.

8. The abrasive particle of claim 1, wherein the body further comprises a first intergranular phase comprising magnesium.

9. The abrasive particle of claim 3, wherein the first intergranular phase comprises spinel (MgAl₂O₄).

10. The abrasive particle of claim 3, wherein the body includes at least 0.5 wt % and not greater than 12 wt % of the first intergranular phase for the total weight of the body.

11. The abrasive particle of claim 1, wherein the body further comprises a second intergranular phase comprising zirconium and the body includes at least 0.5 wt % and not greater than 10 wt % of the second intergranular phase for the total weight of the body.

12. The abrasive particle of claim 3, wherein the first intergranular phase is present in a first content (C1), measured as a weight percent for a total weight of the body, and the second intergranular phase is present in a second content (C2), measured as a weight percent for a total weight of the body, and wherein the body comprises a ratio C1/C2 of not greater than 10 and at least 1.1.

13. The abrasive particle of claim 1, wherein the average crystallite size is at least 0.07 microns and not greater than 0.17 microns

14. The abrasive particle of claim 1, wherein the body has an average strength of least 400 MPa and not greater than 900 MPa and wherein the body has a relative friability of least 106% and not greater than 250%.

15. A coated abrasive article including at least one abrasive particle of the plurality of abrasive particles is the abrasive particle of claim 1.

16. The abrasive particle of claim 2, wherein the average crystallite size is at least 0.07 microns and not greater than 0.17 microns.

17. The abrasive particle of claim 2, wherein the body has an average strength of least 400 MPa and not greater than 900 MPa and wherein the body has a relative friability of least 106% and not greater than 250%.

18. The abrasive particle of claim 2, wherein the body further comprises a first intergranular phase comprising magnesium

19. The abrasive particle of claim 2, wherein the body includes at least 90 wt % and not greater than 99 wt % alumina for the total weight of the body

20. The abrasive particle of claim 3, wherein the body has an average strength of least 400 MPa and not greater than 900 MPa and wherein the body has a relative friability of least 106% and not greater than 250%.
